(19) United States
(12) Patent Application Publication
(10) Pub. No.: US 2014/0309007 A1
(43) Pub. Date: Oct. 16, 2014

(54) Systems and Methods for Conducting Interactive Fantasy Sports Games

(71) Applicants: Mark Joseph Volzer, Arlington, VA (US); Scott Traeye Edington, Arlington, VA (US); Robert Dolafi, Ashburn, VA (US)

(72) Inventors: Mark Joseph Volzer, Arlington, VA (US); Scott Traeye Edington, Arlington, VA (US); Robert Dolafi, Ashburn, VA (US)

(73) Assignee: In Game Fantasy Sports, LLC, Arlington, VA (US)

(21) Appl. No.: 14/231,685

(22) Filed: Mar. 31, 2014

Related U.S. Application Data
(60) Provisional application No. 61/812,717, filed on Apr. 16, 2013.

(51) Int. Cl. A63F 13/30

(52) U.S. Cl. CPC A63F 13/12
USPC 463/16

(57) ABSTRACT

The disclosure relates to systems and methods for conducting fantasy sports games. The disclosed systems and methods implement interactive games in which participants in the games earn scores derived from statistics of real world sporting events. According to an embodiment, during a real world sporting event, a participant in a fantasy sports game may select a roster of players from the real world sporting event for one or more predefined scoring intervals in the sporting event. The predefined scoring intervals may correspond to specified time periods, plays or possessions during the sporting event, or other actions/action sequences, for example. The participant may receive a score for each predefined scoring interval based on the actions/performance of the selected roster of players during each scoring interval. The disclosed systems and methods provide fantasy sports participants a greater level of interaction with fantasy sports games, greater flexibility in roster selection, and the ability to participate in fantasy sports games that take place over durations than the duration of traditional fantasy sports leagues.

This application claims the benefit of U.S. Provisional Application No. 61/812,717, filed on Apr. 16, 2013, the entire disclosure of which is incorporated herein by reference.

### BACKGROUND OF THE INVENTION

1. Field of the Invention

The disclosure concerns systems and methods for conducting fantasy sports games. More specifically, the disclosure relates to interactive games in which participants in the games earn scores derived from statistics of real world sporting events.

2. Description of the Art

Fantasy sports leagues and games, from rotisserie baseball to fantasy sports leagues for sports such as football and basketball, are extremely popular. In general, fantasy sports leagues/games involve participants joining leagues in-person or online, then choosing/drafting rosters of players from a real world sports league that will form the participants' fantasy teams for the entirety of a real world sports league season or even over multiple seasons.

Conventional fantasy sports leagues have a few shortcomings. In conventional fantasy sports leagues, multiple participants in the same league cannot select the same players. Each participant's roster is maintained over the course of a fantasy season corresponding to a real world sports season and participants choose which players to “play” (e.g., make active for scoring purposes in the fantasy competition) for a particular real world sporting event/game based on real world team and player matchups and scheduling. During the fantasy season, players are added to a participant's roster via signings and releases, or trades with other participants within the same league. However, the majority of a participant's roster typically remains the same throughout a fantasy season. Changes to the players a participant has active can only be made at predefined time periods, typically at time periods before and after a real world sporting event/game, but not during a real world sporting event/game. Furthermore, participants in traditional fantasy sports contests are scored on a cumulative, per-game basis over one or more complete seasons. Thus, traditional fantasy sports leagues require long-term involvement of participants, but provide limited interaction on the part of the participants.

Additionally, a fantasy sports season typically is confined to the regular season of the real sports league and does not extend into post-regular season playoffs or tournaments in order to allow rosters to remain constant. Therefore, participants in fantasy sports leagues often cannot participate in fantasy sports during some of the most exciting times in real world sports.

In view of the above, it is desirable to provide systems and methods for conducting fantasy sports games that offer participants a greater level of interaction and roster flexibility during competitions. It is also desirable to provide systems and methods for conducting fantasy sports games in single sessions such that participants are not limited to playing fantasy games over full real world sports seasons, and such that participants have the ability to play fantasy sports games corresponding to post-regular season, real world sporting events.

### SUMMARY OF THE INVENTION

The disclosure relates to systems and methods for conducting fantasy sports games in which participants in the games earn scores derived from statistics of real world sporting events. The disclosed systems and methods enable participants to play fantasy games in a more interactive fashion by providing gaming sessions based on scoring intervals that correspond to specified/predefined time periods, possessions, plays, and/or other actions or series of actions in real world sporting events.

According to an embodiment, a system for conducting a fantasy sports game may include a statistics source, at least one client device and a scoring engine in communication with the statistics source and at the least one client device. The statistics source may include at least one processor and/or a least one memory device configured to store performance statistics of players performing in a sporting event during at least one scoring interval corresponding to a specified time period within the sporting event, a possession of the sporting event or a play of the sporting event. The at least one client device may include a gaming application configured to receive user input from a user including fantasy roster information for the at least one scoring interval, wherein the fantasy roster information includes a selection of one or more players among the players performing in the sporting event. The scoring engine may include at least one processor and/or at least one memory device configured to receive the performance statistics from the statistics source and apply a scoring algorithm to the performance statistics to generate player scores for the at least one scoring interval, wherein the player scores are associated with the players performing in the sporting event. The at least one processor and/or at least one memory device of the scoring engine may be configured to receive the fantasy roster information from the client device and apply the player scores to the fantasy roster information to generate a user score associated with the user for the at least one scoring interval.

According to another embodiment, a system for conducting a fantasy sports game may include a statistics source, and a scoring engine in communication with the statistics source and at least one client device. The statistics source may include at least one processor and/or a least one memory device configured to store performance statistics of players performing in a sporting event during at least one scoring interval corresponding to a specified time period within the sporting event, a possession of the sporting event or a play of the sporting event. The scoring engine may include at least one processor and/or at least one memory device configured to receive the performance statistics from the statistics source and apply a scoring algorithm to the performance statistics to generate player scores associated with the players performing in the sporting event for the at least one scoring interval. The at least one processor and/or at least one memory device of the scoring engine may be configured to receive, from the at least one client device, user input including fantasy roster information associated with a user of the at least one client device for the at least one scoring interval. The fantasy roster information may include a selection of one or more designated players among the players performing in the sporting event. The at least one processor and/or at least one memory device of the scoring engine may be further configured to apply the player scores to the fantasy roster information to generate a user score associated with the user for the at least one scoring interval.

According to another embodiment, a method for conducting a fantasy sports game is provided. According to the method, a statistics source including at least one processor and/or at least one memory device may store performance statistics of players performing in a sporting event during at least one scoring interval corresponding to a selected time interval of the sporting event, a possession of the sporting event or a play of the sporting event. At least one client device including at least one processor and/or at least one memory device may receive user input including fantasy roster information for the at least one scoring interval. The fantasy roster information may include a selection, by a user of the at least one client device, of one or more designated players among the players performing in the sporting event. The fantasy roster information may be sent from the at least one client device to a scoring engine including at least one processor and/or at least one memory device. The performance statistics may be sent from the statistics source to the scoring engine. The scoring engine may apply a scoring algorithm to the performance statistics to generate player scores for the at least one scoring interval, wherein the player scores are associated with the players performing in the sporting event. The scoring engine may apply the player scores to the fantasy roster information to generate a user score associated with the user for the at least one scoring interval.

The above objects, features and advantages of the invention are illustrative, and not exhaustive, of those that can be achieved by the invention. Thus, these and other objects, features and advantages of the invention will be apparent from the description herein and appended drawings, both as embodied herein and as modified in view of any variations that will be apparent to those skilled in the art.

### BRIEF DESCRIPTION OF THE DRAWINGS

FIG. 1 is a schematic diagram of a system for conducting interactive fantasy sports games, according to an embodiment of the invention.

FIG. 2 shows an exemplary graphical user interface that can be displayed on a client device during a fantasy football game conducted by the system of FIG. 1.

FIG. 3 shows an exemplary graphical user interface that can be displayed on a client device during a fantasy baseball game conducted by the system of FIG. 1.

FIG. 4 shows an exemplary graphical user interface that can be displayed on a client device during a fantasy basketball game conducted by the system of FIG. 1.

### DETAILED DESCRIPTION OF THE INVENTION

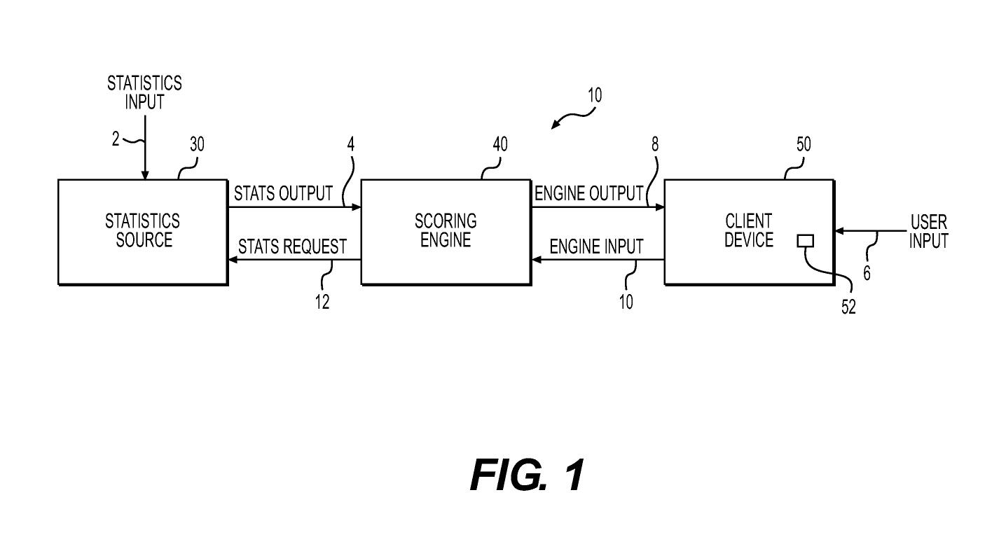

Referring to the appended drawing FIGS. 1-4, the disclosure concerns systems and methods for conducting fantasy sports competitions (or, “fantasy games”) in which participants in the fantasy games compete to earn scores derived from statistics of real world sporting events. In the interest of clarity, it is noted that, throughout the disclosure, a participant in fantasy sports games/leagues is referred to as a “participant” or “user”, and athletes in real world sporting events that form the bases for fantasy sports contests are referred to as “players.”

FIG. 1 shows an exemplary architecture of a fantasy sports system for conducting fantasy sports games. As shown in FIG. 1, an exemplary fantasy sports system 10 may include a statistics source 30, a real-time scoring engine 40 in communication with the statistics source 30, and one or more client devices 50 in communication with the scoring engine 40. It is noted that, while only one client device 50 is shown, the system 10 may, and likely will, include a plurality of client devices 50 in communication with the scoring engine 40 at any given time during real world sporting events and associated fantasy sports games. The fantasy sports system 10 enables participants to engage in fantasy sports games, wherein participants choose fantasy roster members among players/athletes in a real world sporting event for a predefined scoring interval while the sporting event is in progress. A roster member chosen by a participant may be an individual athlete/player or a group/unit of athletes/players (e.g., offense, defense, special team unit or players playing a specified position/role on the sports team). The predefined scoring interval may be a specified time interval or a play, possession or other action/sequence of actions within the sporting event, for example. Thus, the predefined scoring interval may correspond to an entire real world sporting event or the scoring interval may correspond to a time period, a play, a possession or any defined action/sequence of actions that constitutes only a portion of the real world sporting event (i.e., a segment of the sporting event that is less than the entire sporting event). Scoring of participants may be assessed in real-time or substantially in real-time for each scoring interval.

The statistics source 30 may include one or more servers or computers configured to receive and store input statistics data 2 related to the performance of players in real world sporting events. Such servers or computers may include one or more processors, one or more memory devices, firmware and/or software, or any combination of processors, memory devices, firmware and software configured to receive and store the input statistics data 2. The input statistics data 2 may be collected in real-time and may correspond to predefined scoring intervals. As indicated above, the predefined scoring intervals may each correspond to a specified time period, a play, a possession or any defined action/sequence of actions that constitutes only a portion of the real world sporting event. According to a preferred embodiment, a scoring interval may correspond to a 10-second, 20-second or 30-second time period of action in the sporting event. The statistics data 2 may be contemporaneously input to the statistics source 30 by personnel assigned to view and record real world sporting events. Alternatively, the input statistics data 2 may be provided by a third-party data provider of real-time data, such as stats.com. The types of real world sporting events for which the input statistics data 2 can be stored may include, for example, football games, baseball games, basketball games, hockey games, golf matches/tournaments and tennis matches/tournaments. The real world sporting events may be professional events in leagues such as the National Football League (NFL), Major League Baseball (MLB), National Basketball Association (NBA), National Hockey League (NHL), Professional Golf Association (PGA) and/or World Tennis Association (WTA), for example. Additionally, the real world sporting events may be amateur events at the collegiate or high school level, for example. It should be understood that the aforementioned lists of sporting events and leagues are merely examples, and that statistics data from other types of sporting events and other leagues can be input into the statistics source 30.

As indicated above, the statistics source 30 may include a plurality of server computers for storing input statistics data 2. According to an embodiment, a particular server/computer, or group of servers/computers, may be assigned to one or more real world sports or leagues for which the system 10 conducts fantasy sports games, such that each server/computer of the statistics source 30 may only store data for those real world sports/leagues to which that server/computer is assigned.

Still referencing FIG. 1, the scoring engine 40 may be operable to execute instructions (e.g., instructions of one or more software and/or firmware applications) for processing information received from the statistics source 30 and the client device 50. Additionally, the scoring engine 40 may be configured to store information related to user/participant profiles, fantasy league attributes, real world sport attributes, community (an ad hoc or location-based collection of participants) attributes, fantasy game session attributes, data concerning participant and league scoring, and participant rosters, for example. The scoring engine 40 may be embodied in one or more processors, one or more memory devices, firmware and/or software, or any combination of processors, memory devices, firmware and software. The scoring engine 40 may be integrated with the statistics source 30, or it may be included in a separate computer device/server device in communication with the statistics source 30 by a network connection or an Internet connection, for example. The scoring engine 40 may be operable to perform several functions in the system 10. Specifically, the scoring engine 40 may be responsible for: user/participant registration in the system 10; data management for the fantasy sports/fantasy leagues that are set up in the system 10; creation of fantasy leagues, fantasy communities and fantasy game sessions; management of fantasy leagues, fantasy communities and fantasy game sessions; communicating information about fantasy games, leagues, communities, scoring, rosters and schedules to participants; and applying a scoring algorithm to generate fantasy scores for participants based on statistical output data 4 from the statistical source 30.

Continuing with reference to FIG. 1, the client device 50 may be a computer device such as a personal computer (PC), tablet computer, smartphone, video game system, portable USB device or dedicated computer terminal. According to an embodiment, the device 50 may be a computer device that is part of a gaming hub in a public establishment, such as a restaurant, sports bar, video game arcade, barber shop or any other public facility. A gaming application 52, such as a PC application, tablet computer application, mobile device application or web-based application (e.g., web browser) may be installed on the client device 50. The gaming application 52 may be embodied in firmware and/or software and may include written instructions executable to enable the client device 50 to communicate with the scoring engine 40 and the statistics source 30, and thereby enable a user/participant to participate in fantasy sports games. The gaming application 52 may also be operable to output live or time-delayed video and audio signals from a real world sporting event upon which a fantasy game is based to the client device 50. The video and audio signals may be supplied by the scoring engine 40, the statistics source 30 or another source in communication with the client device 50, for example.

The client device 50 may display a graphical user interface (GUI) generated by execution of the software application 52 for conveying gaming information to the participant and receiving user input information 6 from the participant. The user input information 6 may be entered via one or more input devices such as a touchscreen, keyboard, mouse, and/or another type of input device associated with the client device 50. The user input information 6 may include initial setup information that is input prior to the commencement of a real world sporting event or season. Such initial setup information may include user registration/profile information and game session creation/modification information for a fantasy league or fantasy community, for example. The user input information 6 may also include fantasy gameplay instructions input before or during a real world sporting event. Fantasy gameplay instructions may include roster selections/modifications before and during a real world sporting event, for example. A GUI displayed by the client device 50 during a fantasy game may also present live or time-delayed video (full motion and/or still) from the real world sporting event upon which a fantasy game is based. The GUI may also enable control over the output of audio from the sporting event by the client device 50. The gaming application 52/GUI may also be configured to enable multiple users/participants to provide user input information 6, and may accordingly be configured to convey gaming information to the multiple users/participants, thereby enabling the multiple users/participants to participate in a fantasy game using a single client device.

When a participant inputs user input information 6 including setup information into the client device 50, the client device 50 may send engine input information 10 to the scoring engine 40, which may then process the engine input information 10 to register the participant, create or modify the participant's user profile, or create or modify a fantasy league/fantasy community/fantasy game session in accordance with the user input information 6. The scoring engine 40 may create and modify user registrations, user profiles and fantasy leagues in a known manner.

As indicated above, in addition to establishing traditional fantasy leagues in which participants compete against one another, the scoring engine 40 may establish fantasy communities in which a participant competes against other participants in the community for single fantasy game sessions corresponding to a real time sporting event. Therefore, a participant may have the option to participate in single fantasy game sessions rather than join a fantasy league that is fixed for an entire season. Fantasy communities may either be ad hoc communities including user devices 50/participants that are connected to the system 10 through a common Internet portal, or location-based communities including similarly located user devices 50/participants connected to the system 10 through a common hub. Location-based communities may be set up, for example, in public facilities, and participants in such facilities may use client devices 50 such as laptop computers, tablet computers, USB devices and smartphones to access the system 10. Additionally, public facilities may provide dedicated computer terminals or game systems owned by the facility as client devices 50 associated with location-based communities.

When a participant plays a fantasy sports game on the system 10, the participant may enter user input information 6 including a selection of roster members for a predefined scoring interval corresponding to a specified time period, a play, a possession or another action/sequence of actions within a real world sporting event upon which the fantasy sports game is based. The roster members may be selected from players in the real world sporting event. Engine input information 10 including roster member information for the participant may then be sent from the client device 50 to the scoring engine 40. Based on the engine input information 10, the scoring engine 40 may then send a statistics request 12 to the statistics source 30 requesting performance statistics of the selected roster members for the scoring interval. The statistics source 30 may then send statistics output information 4 including the performance statistics of the selected roster members to the scoring engine 40. Alternatively, the statistics request 12 may request performance statistics for all players in the sporting event and the statistics output information 4 may include the performance statistics for all players in the sporting event. According to further alternate embodiments, the statistics source 50 may automatically send statistics output information 4 including the performance statistics for all players in the sporting event to the scoring engine 40.

The scoring engine 40 may then apply a scoring algorithm to calculate a user score for the participant for the scoring interval. More specifically, the scoring algorithm may generate a player score for each player on the participant's roster (or for every player in the real world sporting event) by applying a specific scoring system that allocates points to the players based on the players' actions in the real world sporting event during the scoring interval. The points accumulated by each player on the participant's roster for the scoring interval may be added together to generate the participant's user score for the scoring interval. The scoring engine 40 may calculate a participant's total score at a given stage of the fantasy game by summing the participant's user scores for each scoring interval that has taken place. Once the participant's user score is calculated for a scoring interval, the scoring engine 40 may generate engine output information 8, which may include scoring information such as the participant's user score for the scoring interval, the participant's total score at that time, the scores of the participant's competitors for the scoring interval and the total scores of the participant's competitors at that time. The engine output information 8 may be stored in the scoring engine 40 and sent to the client device 50, which may display or otherwise convey the scoring information to the participant.

According to alternate embodiments (not shown), the gaming application 52 may receive the player scores from the scoring engine 40, calculate the participant's user scores and total scores based on the player scores and the participant's roster information, and then send the user scores and total scores to the scoring engine 40 for storage.

Exemplary Scoring Systems

Tables 1-3 below provide exemplary fantasy sports scoring systems. The exemplary scoring systems provide examples of how fantasy game points may be allocated to players/athletes in real world sporting events, and accordingly to participants in associated fantasy sports games for a given scoring interval. It should be understood that the scoring systems indicated in Tables 1-3 are merely examples and other scoring systems may be implemented.

Table 1 provides an exemplary scoring system for a fantasy football game associated with a real world football game.

TABLE 1
Fantasy Football Scoring

| Position or Penalty | Situation | Points |
|---|---|---|
| Offensive line | Pass: No pressure on | +2 |
| | quarterback (QB) | |
| Offensive line | Pass: Completed Pass | +2 |
| Offensive line | Pass: Every 10 yards over 10 | +5 |
| | yards | |
| Offensive line | Pressure on QB | −2 |
| Offensive line | Sack | −10 |
| Offensive line | Run: 0-3 yards | 0 |
| Offensive line | Run: 3-5 yards | 1 |
| Offensive line | Run: 6-10 yards | 2 |
| Offensive line | Run: Every 10 yards over 10 | 5 |
| | yards | |
| Offensive line | Run: negative yards | −1 point per negative yard |
| Offensive line | Run: first down | 3 |
| Offensive line | Pass: first down | 3 |
| Offensive line | Run: touchdown (TD) | 5 |
| Offensive line | Pass: touchdown (TD) | 5 |
| Offensive line | Sack over 5 yards | 1 point per yard over 5 yards |
| Quarterback | Competed pass | 3 |
| Quarterback | Incomplete pass | −3 |
| Quarterback | Interception (INT) | −20 |
| Quarterback | Sack | −10 |
| Quarterback | Fumble | −5 |
| Quarterback | Fumble lost | −20 |
| Quarterback | INT returned | −5 points for every 10 yards over |
| | | 10 yards |
| Quarterback | INT returned for TD | −7 |
| Quarterback | Fumble returned for TD | −7 |
| Quarterback | Completed pass every 10 yards | 5 |
| | over 10 yards | |
| Quarterback | Completed pass 6-10 yards | 5 |
| Quarterback | First down | 3 |
| Quarterback | Touchdown | 7 |
| Quarterback | Sack every yard over 5 yards | 1 point per yard |
| Quarterback | Run 0-3 yards | 0 |
| Quarterback | Run 4-6 yards | 1 |
| Quarterback | Run 7-10 yards | 2 |
| Quarterback | Run over 10 yards | 5 points for every 10 yards over |
| | | 10 yards |
| Running Back | Run 0-3 yards | 0 |
| Running Back | Run 4-6 yards | 1 |
| Running Back | Run 7-10 yards | 2 |
| Running Back | Run over 10 yards | 5 points for every 10 yards over |
| | | 10 yards |
| Running Back | Fumble | −5 |
| Running Back | Fumble lost | −20 |
| Running Back | Fumble lost returned | −5 points for every 10 yards over |
| | | 10 yards |
| Running Back | Fumble returned for TD | −7 |
| Running Back | Reception 0-5 yards | 1 |
| Running Back | Reception 6-10 yards | 2 |
| Running Back | Reception every 10 yards over | 5 |
| | 10 yards | |
| Running Back | Drop | −10 |
| Running Back | Tipped interception (INT) | −20 |
| Running Back | Tipped INT return | −5 points for every 10 yards over |
| | | 10 yards |
| Running Back | Tipped INT returned for TD | −7 |
| Wide Receiver/Tight End | Reception 0-5 yards | 1 |
| Wide Receiver/Tight End | Reception 6-10 yards | 2 |
| Wide Receiver/Tight End | Reception over 10 yards | 5 points every 10 yards over 10 |
| | | yards |
| Wide Receiver/Tight End | Drop | −10 |
| Wide Receiver/Tight End | Tipped INT | −20 |
| Wide Receiver/Tight End | Tipped INT return | −5 points for every 10 yards over |
| | | 10 yards |
| Wide Receiver/Tight End | Tipped INT returned for TD | −7 |
| Penalty | Holding | −10 |
| Penalty | False start | −5 |
| Penalty | Illegal motion | −5 |
| Penalty | Hands to the face | −10 |
| Penalty | Illegal block | −10 |
| Penalty | Clipping | −15 |
| Penalty | Chop block | −15 |
| Penalty | Personal foul | −15 |
| Penalty | Illegal formation | −5 |
| Penalty | Grounding | −15 |
| Penalty | Illegal forward pass | −10 |
| Penalty | Defensive holding | −15 |
| Penalty | Defensive pass interference | −10 + −5 points per 10 yards |
| | | over 10 yards |
| Penalty | Offensive pass interference | −15 |
| Penalty | Tripping | −10 |
| Penalty | Face mask | −15 |
| Penalty | Roughing the passer | −15 |
| Penalty | Roughing the kicker | −15 |
| Defense | Run 0-3 yards | 0 |
| Defense | Tackle | 3 |
| Defense | QB Pressure | 5 |
| Defense | Sack | 10 |
| Defense | Sack 5-10 yards | 5 |
| Defense | Sack 10+ yards | 10 |
| Defense | Tackle for loss (TFL) | 5 |
| Defense | TFL 5-10 yards | 5 |
| Defense | TFL 10 yards | 10 |
| Defense | Pass defensed | 10 |
| Defense | Incompletion | 5 |
| Defense | Interception (INT) | 20 |
| Defense | INT return | 5 points for every 10 yards over |
| | | 10 yards |
| Defense | INT return for TD | 7 |
| Defense | Forced fumble | 10 |
| Defense | Fumble recovery | 20 |
| Defense | Fumble return | 5 points for every 10 yards over |
| | | 10 yards |
| Defense | Fumble return TD | 7 |
| Defense | 3 downs and out | 5 |
| Special teams kicking | Touchback | 3 |
| Special teams kicking | Every return yard under NFL | 1 |
| | average | |
| Special teams kicking | Punt inside 20-yard line | 1 point for every 2 yards |
| Special teams kicking | Field goal (FG) | 3 |
| Special teams kicking | FG over 35 yards | 2 point for every 5 yards |
| Special teams kicking | Punt return TD | −7 |
| Special teams kicking | Punt return | −1 point for every 5 yards over |
| | | NFL average |
| Special teams kicking | Kickoff return | −1 point for every 5 yards over |
| | | NFL average |
| Special teams kicking | Kickoffs return TD | −7 |
| Special Teams Returning | Kick return | 1 point for every 5 yard over |
| | | NFL average |
| Special Teams Returning | Kick return | −1 point for every yard under |
| | | NFL average |
| Special Teams Returning | Kick return TD | 7 |

Table 2 provides an exemplary scoring system for a fantasy basketball game associated with a real world basketball game.

TABLE 2
Fantasy Basketball Scoring

| Position | Situation | Points |
|---|---|---|
| Offense | 2-point basket | 2 |
| Offense | 3-point basket | 3 |
| Offense | Free throw | 1 |
| Offense | Draw a foul | 1 |
| Offense | Assist 2-point basket | 2 |
| Offense | Assist 3-point basket | 3 |
| Offense | Offensive rebound | 2 |
| Defense | Defensive rebound | 1 |
| Defense | Steal | 2 |
| Defense | Block | 2 |
| Defense | Block & get possession | 3 |
| Defense | Shot clock violation | 2 |
| Offense | Shot clock violation | −2 |
| Offense | Turnover | −2 |

Table 3 provides an exemplary scoring system for a fantasy football game associated with a real world football game.

TABLE 3
Fantasy Baseball Scoring

| Position | Situation | Points |
|---|---|---|
| Pitcher | Select pitch location | 1 |
| Pitcher | Select pitch type | 1 |
| Pitcher | Select pitch Speed | 1 |
| Batter | Single base hit | 1 |
| Batter | Double base hit | 3 |
| Batter | Triple base hit | 5 |
| Batter | Home run | 7 |
| Batter | Run scored | 3 |
| Batter | Run batted in (RBI) | 3 |
| Batter | Swing and miss | −1 |
| Batter | Strike out | −3 |
| Pitcher | Strike out | 3 |
| Pitcher | Ground out | 2 |
| Pitcher | Fly out | 2 |
| Pitcher | Double play | 3 |
| Pitcher | Triple Play | 5 |
| Fielder | Out | 2 |
| Fielder | Double play | 3 points for all players involved |
| Fielder | Triple Play | 5 points for all players involved |
| Batter | Hit into double play | −3 |
| Batter | Hit into triple play | −5 |
| Runner | Steal second base | 3 |
| Runner | Steal third base | 5 |
| Runner | Steal home plate | 7 |
| Runner | Picked off | −3 |
| Runner | Caught stealing | −3 |
| Runner | Picked off at second base | −5 |
| Runner | Picked off at third base | −7 |
| Runner | Caught stealing third base | −5 |
| Runner | Caught stealing home plate | −7 |
| Catcher | Throw out at second base | 3 |
| Catcher | Throw out at third base | 5 |
| Catcher | Thrown out at home plate | 7 |

An exemplary description of the gameplay in fantasy sports game session conducted by the system 10 is provided below.

Exemplary Fantasy Game Play

Prior to the start of a real world sporting event, each participant in a fantasy sports game session may select his roster of players from the real world sporting event for a first predefined scoring interval of the fantasy sports game by entering roster selections into a respective client device 50. Roster selections may be made, for example, by a participant entering inputs through a graphical user interface (GUI) displayed on the respective user device 50. Each participant may select the same number of players (which can be predefined by the scoring engine 40 or the software application 52) for his roster for each scoring interval. According to an embodiment, participants are not restricted as to which players they choose. If they wish to do so, participants may choose one or more of the same players for their rosters that their competitors choose. Each participant may also select players from more than one team (e.g., both teams of two opposing teams) in the real world sporting event.

At the end of the first scoring interval, participants may elect to keep their same rosters of players or replace any or all of the players on their rosters for the next scoring interval by again entering roster selections into their client devices 50. If a player does not make a roster selection for the next scoring interval, the client device 50 may be configured to automatically repeat the participant's roster selection from the first scoring interval, make a random roster selection, or make no roster selection for the next scoring interval. While the participants are making roster selections for a next scoring interval, the performance statistics of real world players for the first scoring interval may be applied to the scoring algorithm in the scoring engine 40 to generate user scores for the participants for the first scoring interval. Then, the participants may be assigned user scores for the first scoring interval, and these user scores may be transmitted to and displayed/communicated by the participants' client devices 50.

The fantasy sports game may continue as the real world sporting event continues. Participants may continue to select roster players for subsequent scoring intervals (either affirmatively or by default selection by the client device) and score points for each scoring interval based on the actions of their roster of players. Participants' scores for each scoring interval as well as participants' total (cumulative) scores at the end of each scoring interval may be calculated after the scoring interval and then transmitted to and displayed/communicated by the participants' client devices 50. At the end of the real world sporting event, the fantasy sports game ends and participants' final, total scores may be calculated by summing the participants' scores from each interval. The participant with the highest final score may be determined to be the winner of the fantasy sports game.

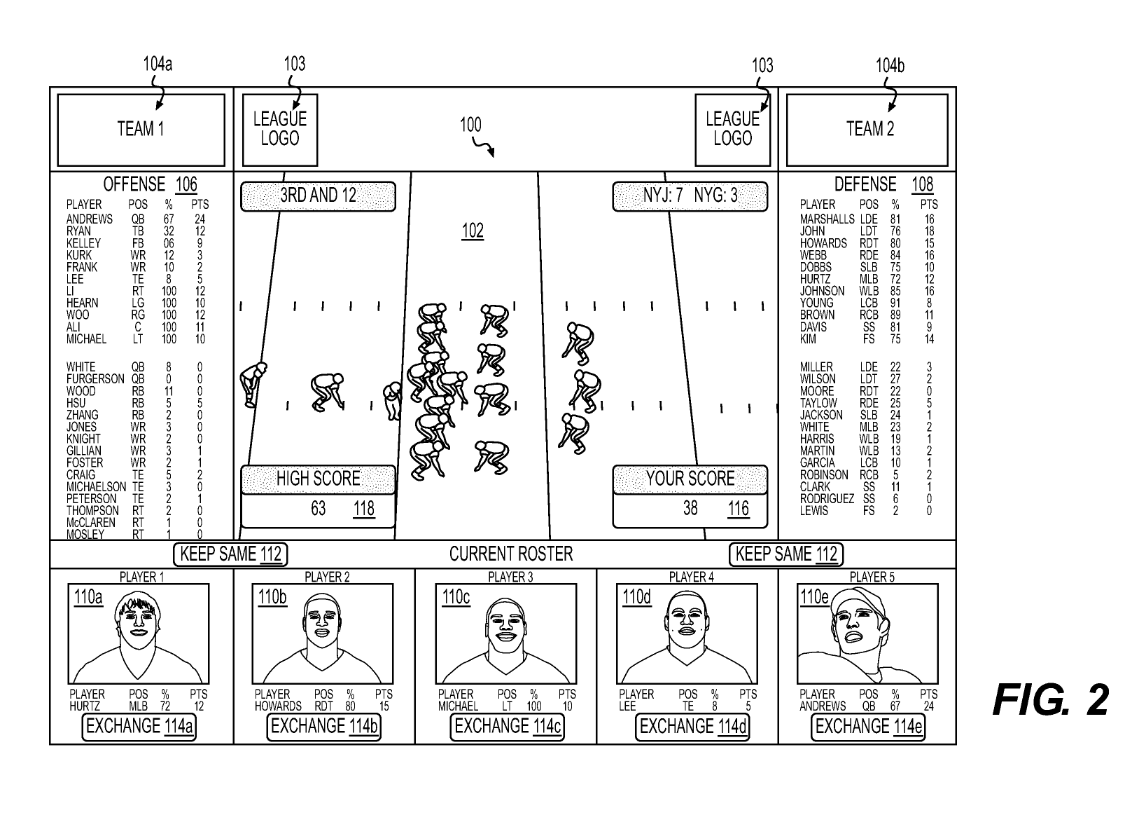

FIGS. 2-4 show exemplary GUIs that may be displayed on a user device 50 for conveying information about a fantasy sports game to a participant and receiving input information (e.g., roster selections) from a participant during a fantasy sports game. The GUI 100 shown in FIG. 2 is associated with a fantasy football game corresponding to a real world football game. As shown in FIG. 2, the GUI 100 may include a video image 102 (full motion and/or still) of the real world football game, images 104a, 104b of team logos associated with the football teams competing in the real world football game, images 103 of the league logo for the real world league to which the football teams belong, real world player images 106, 108 providing information regarding players on the real world football teams, the points earned by the players as calculated by the scoring engine 40 and the usage percentage of each player on fantasy rosters in the fantasy game session. The GUI 100 may further include images 110a-110e of players on the participant's fantasy roster, icons 112 that are selectable to instruct the system 10 to keep the same roster for the participant in the next scoring interval, and icons 114a-114e that are selectable to instruct the system 10 to replace particular roster members. Additionally, the GUI 100 may include an image 116 indicating the participant's current total score in the fantasy game session, and an image 118 indicating a highest total score among all competitors in the fantasy game session.

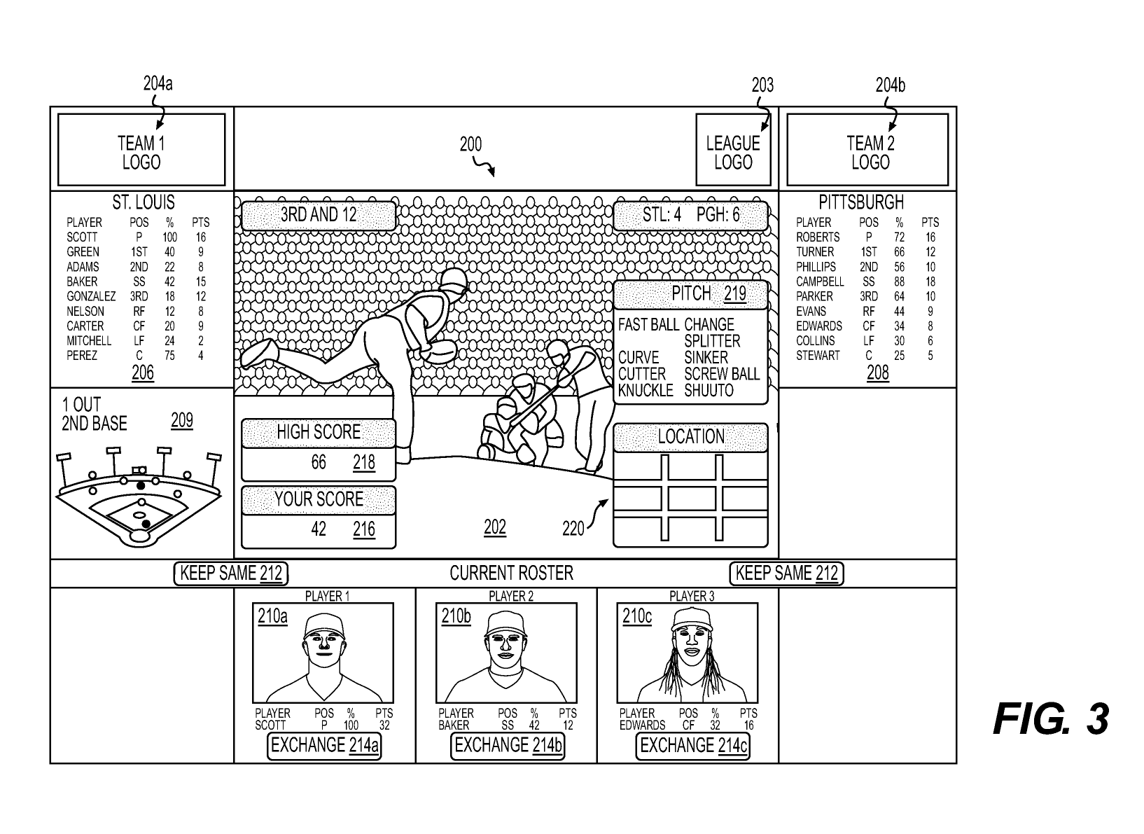

The GUI 200 shown in FIG. 3 relates to a fantasy baseball game corresponding to a real world baseball game. As shown in FIG. 3, the GUI 200 may include a video image 202 (full motion and/or still) of the real world baseball game, images 204a, 204b of team logos associated with the baseball teams competing in the real world baseball game, an image 203 of the league logo for the real world league to which the baseball teams belong, real world player images 206, 208 providing information regarding players on the real world baseball teams, the points earned by the players as calculated by the scoring engine 40 and the usage percentage of each player on fantasy rosters in the fantasy game session. A game status icon 209 may be provided to indicate the number of outs and positions of players on the field in the real world baseball game. The GUI 200 may further include images 210a-210c of players on the participant's fantasy roster, icons 212 that are selectable to instruct the system 10 to keep the same roster for the participant in the next scoring interval, and icons 214a-214c that are selectable to instruct the system 10 to replace particular roster members. The GUI 200 may also include an image 216 indicating the participant's current total score in the fantasy game session, and an image 218 indicating a highest total score among all competitors in the fantasy game session. Additionally, images 219, 220 indicating a pitch type and pitch location may be included in the GUI 200.

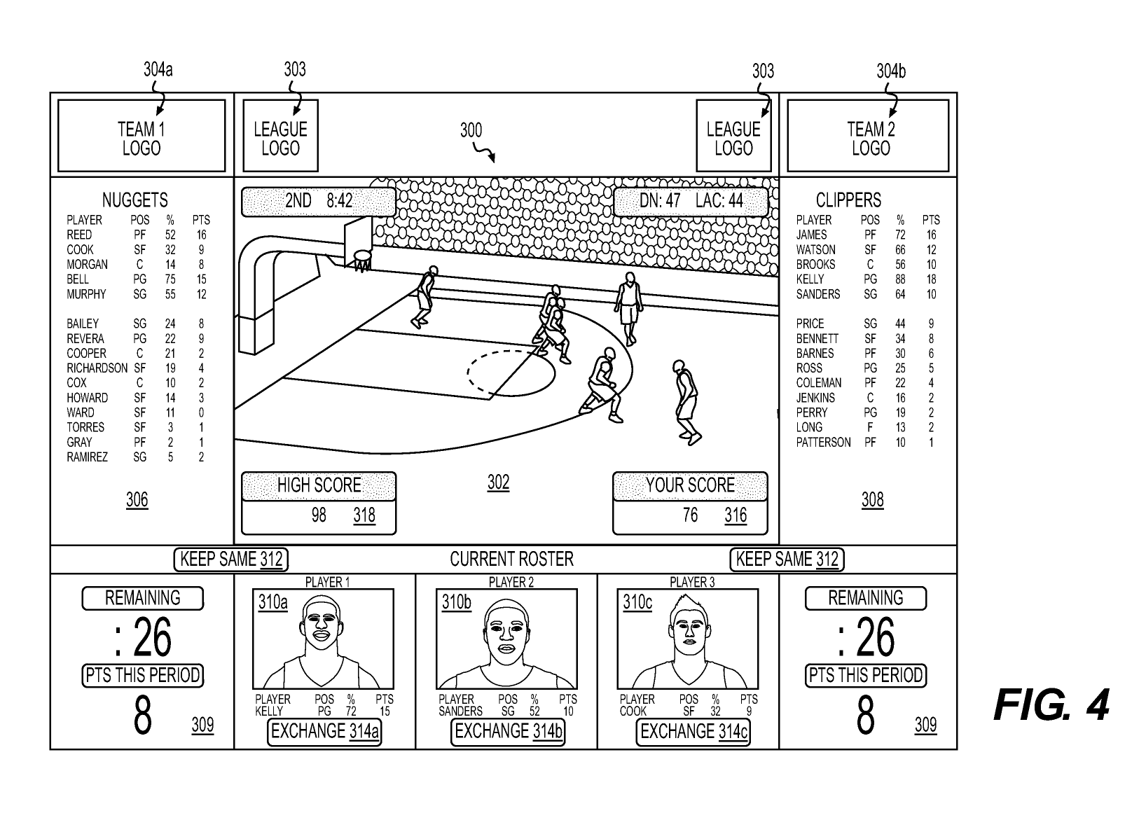

The GUI 300 shown in FIG. 4 relates to a fantasy basketball game corresponding to a real world basketball game. As shown in FIG. 4, the GUI 300 may include a video image 302 (full motion and/or still) of the real world basketball game, images 304a, 304b of team logos associated with the basketball teams competing in the real world basketball game, an image 303 of the league logo for the real world league to which the basketball teams belong, real world player images 306, 308 providing information regarding players on the real world baseball teams, the points earned by the players as calculated by the scoring engine 40 and the usage percentage of each player on fantasy rosters in the fantasy game session. A game status icon 309 may be provided to indicate the amount of time remaining in the scoring interval for the fantasy game. The GUI 300 may further include images 310a-310c of players on the participant's fantasy roster, icons 312 that are selectable to instruct the system 10 to keep the same roster for the participant in the next scoring interval, and icons 314a-314c that are selectable to instruct the system 10 to replace particular roster members. The GUI 300 may also include an image 316 indicating the participant's current total score in the fantasy game session, and an image 318 indicating a highest total score among all competitors in the fantasy game session.

In the exemplary embodiments depicted in FIGS. 2-4, the video images 102, 202, 302 may be transmitted to the user device 50 by the scoring engine 40, or by another source in communication with the client device 50. The team logo images 104a, 104b, 204a, 204b, 304a, 304b, the real world roster images 106, 108, 206, 208, 306, 308 and the fantasy roster player images 110a-110e, 210a-210c and 310a-310c may be stored/supplied by the scoring engine 40, the gaming application 52 or another source in communication with the client device 50.

While the above discussion provides exemplary embodiments related to football, basketball and baseball, it should be understood that the invention may relate to other sporting events and contests.

It should be apparent that the foregoing describes only selected embodiments of the invention, and numerous changes and modifications may be made to the embodiments disclosed herein by one of ordinary skill in the art without departing from the general spirit and scope of the invention as defined by the following claims and equivalents thereof.

We claim:

1. A system for conducting a fantasy sports game, comprising:
a statistics source including at least one processor and/or a least one memory device configured to store performance statistics of players performing in a sporting event during at least one scoring interval corresponding to a specified time period within the sporting event, a possession in the sporting event or a play in the sporting event;
at least one client device including a gaming application configured to receive user input from a user including fantasy roster information for the at least one scoring interval, wherein the fantasy roster information includes a selection of one or more players among the players performing in the sporting event; and
a scoring engine in communication with the statistics source and the at least one client device, the scoring engine including at least one processor and/or at least one memory device configured to
receive the performance statistics from the statistics source,
apply a scoring algorithm to the performance statistics to generate player scores for the at least one scoring interval, wherein the player scores are associated with the players performing in the sporting event,
receive the fantasy roster information from the client device, and
apply the player scores to the fantasy roster information to generate a user score associated with the user for the at least one scoring interval.

2. The system of claim 1, wherein the at least one scoring interval comprises a plurality of scoring intervals, and the scoring engine is configured to calculate a total score for the user by summing each user score.

3. The system of claim 1, wherein the gaming application is executable to generate a graphic user interface that is operable to receive the user input and display the fantasy roster information.

4. The system of claim 3, wherein the graphic user interface is operable to display images and information associated with the players performing in the sporting event.

5. The system of claim 3, wherein the graphic user interface is operable to display an icon that is selectable by the user to maintain, for a next scoring interval of the at least one scoring interval, the fantasy roster information from a previous scoring interval of the at least one scoring interval.

6. The system of claim 3, wherein the graphic user interface is configured to output full motion video, still video and/or audio from the sporting event.

7. The system of claim 1, wherein the gaming application is a personal computer application, tablet computer application, mobile device application or web browser application.

8. The system of claim 1, wherein the at least one client device is a personal computer, tablet computer, smartphone, video game system, portable universal serial bus device or dedicated computer terminal.

9. The system of claim 1, wherein the scoring interval is a 10-second time period, a 20-second time period or a 30-second time period.

10. The system of claim 1, wherein the scoring engine is configured to establish:
at least one fantasy league in which the user competes against at least one other user for multiple sporting events; and/or
at least one ad hoc or location-based fantasy community in which the user competes against at least one other user for only a single sporting event.

11. A system for conducting a fantasy sports game, comprising:
a statistics source including at least one processor and/or a least one memory device configured to store performance statistics of players performing in a sporting event during at least one scoring interval corresponding to a specified time period within the sporting event, a possession in the sporting event or a play in the sporting event; and
a scoring engine in communication with the statistics source and at least one client device, the scoring engine including at least one processor and/or at least one memory device configured to
receive the performance statistics from the statistics source,
apply a scoring algorithm to the performance statistics to generate player scores associated with the players performing in the sporting event for the at least one scoring interval,
receive, from the at least one client device, user input including fantasy roster information associated with a user of the at least one client device for the at least one scoring interval, wherein the fantasy roster information includes a selection of one or more designated players among the players performing in the sporting event, and
apply the player scores to the fantasy roster information to generate a user score associated with the user for the at least one scoring interval.

12. The system of claim 11, wherein the at least one scoring interval comprises a plurality of scoring intervals, and the scoring engine is configured to calculate a total score for the user by summing each user score.

13. The system of claim 11, wherein the scoring engine is configured to provide, for display by the at least one client device, images and information associated with the players performing in the sporting event.

14. The system of claim 11, wherein the scoring engine is configured to provide, for output by the at least one client device, full motion video, still video and/or audio from the sporting event.

15. The system of claim 11, wherein the scoring interval is a 10-second time period, a 20-second time period or a 30-second time period.

16. The system of claim 11, wherein the scoring engine is configured to establish:
at least one fantasy league in which the user competes against at least one other user for multiple sporting events; and/or
at least one ad hoc or location-based fantasy community in which the user competes against at least one other user for only a single sporting event.

17. A method for conducting a fantasy sports game, comprising:
storing, at a statistics source including at least one processor and/or at least one memory device, performance statistics of players performing in a sporting event during at least one scoring interval corresponding to a specified time period within the sporting event, a possession in the sporting event or a play in the sporting event;
receiving, using at least one client device including at least one processor and/or at least one memory device, user input including fantasy roster information for the at least one scoring interval, wherein the fantasy roster information includes a selection by a user of the at least one client device of one or more designated players among the players performing in the sporting event;
sending the fantasy roster information from the at least one client device to a scoring engine including at least one processor and/or at least one memory device;
sending the performance statistics from the statistics source to the scoring engine;
using the scoring engine, applying a scoring algorithm to the performance statistics to generate player scores for the at least one scoring interval, wherein the player scores are associated with the players performing in the sporting event; and
using the scoring engine, applying the player scores to the fantasy roster information to generate a user score associated with the user for the at least one scoring interval.

18. The method of claim 17, wherein the at least one scoring interval comprises a plurality of scoring intervals, and the scoring engine is configured to calculate a total score for the user by summing each user score.

19. The method of claim 17, comprising executing a gaming application at the at least one client device to generate a graphic user interface that is operable to receive the user input and display the fantasy roster information.

20. The method of claim 19, comprising executing the gaming application to display, via the graphic user interface, images and information associated with the players performing in the sporting event.

21. The method of claim 19, comprising executing the gaming application to display, via the graphic user interface, an icon that is selectable by the user to maintain, for a next scoring interval of the at least one scoring interval, the fantasy roster information from a previous scoring interval of the at least one scoring interval.

22. The method of claim 19, comprising executing the gaming application to output, via the graphic user interface, full motion video, still video and/or audio from the sporting event.

23. The method of claim 17, wherein the at least one client device is configured to communicate with the scoring engine and/or the statistics source using a personal computer application, tablet computer application, mobile device application or web browser application.

24. The method of claim 17, wherein the at least one client device is a personal computer, tablet computer, smartphone, video game system, portable universal serial bus device or dedicated computer terminal.

25. The method of claim 17, wherein the scoring interval is a 10-second time period, a 20-second time period or a 30-second time period.

26. The method of claim 17, comprising establishing, using the scoring engine:
at least one fantasy league in which the user competes against at least one other user for multiple sporting events; and/or
at least one ad hoc or location-based fantasy community in which the user competes against at least one other user for only a single sporting event.
